(19) United States
(12) Patent Application Publication
(10) Pub. No.: US 2026/0001008 A1
(43) Pub. Date: Jan. 1, 2026

(54) METHOD OF IMPROVING FUNCTIONAL DURABILITY OF TOY BUILDING ELEMENTS

(71) Applicant: LEGO A/S, Billund (DK)

(72) Inventors: René MIKKELSEN, Billund (DK); Emil ANDERSEN, Billund (DK); Anne Therese WEYHE, Aalborg (DK)

(73) Assignee: LEGO A/S, Billund (DK)

(21) Appl. No.: 18/880,702

(22) PCT Filed: Jul. 5, 2023
(86) PCT No.: PCT/EP2023/068471

§ 371 Date: Jan. 2, 2025

(30) Foreign Application Priority Data
Jul. 6, 2022 (EP) 22183298.3

(51) Int. Cl. A63H 33/08; B29C 71/02; B29K 33/00; B29K 67/00; B29K 105/00; B29L 31/52

(52) U.S. Cl. CPC A63H 33/086; B29C 71/02; B29K 2033/12; B29K 2067/003; B29K 2105/0005; B29K 2995/0039; B29L 2031/52

(57) ABSTRACT

A method for the manufacture of a toy building element with improved functional durability made of an impact modified amorphous material having an enthalpic relaxation of at least 0.3 J/g, such as in the range of 0.3 to 4 J/g and a shrinkage of maximum 0.2%. The present disclosure also relates to a toy building element with improved functional durability made of an impact modified amorphous material having an enthalpic relaxation of at least 0.3 J/g, such as in the range of 0.3 to 4 J/g and a shrinkage of maximum 0.2%.

### CROSS-REFERENCE TO RELATED APPLICATIONS

The present application is a U.S. National Stage Application of International Application No. PCT/EP2023/068471 filed Jul. 5, 2023, and published on Jan. 11, 2024 as WO2024/008762, which claims the benefit and priority of European Patent Application No. 22183298.3 filed Jul. 6, 2022, each of which is incorporated herein by reference in their entirety for any purpose whatsoever.

### FIELD OF THE DISCLOSURE

The present disclosure relates to a method for the manufacture of a toy building element with improved functional durability made of an impact modified amorphous material having an enthalpic relaxation of at least 0.3 J/g, such as in the range of 0.3 to 4 J/g and a shrinkage of maximum 0.2%. The present disclosure also relates to a toy building element with improved functional durability made of an impact modified amorphous material having an enthalpic relaxation of at least 0.3 J/g, such as in the range of 0.3 to 4 J/g and a shrinkage of maximum 0.2%.

### BACKGROUND

Toy building elements have been marketed for many years. They are typically manufactured by injection moulding a polymeric material. The injection moulding process takes place at a temperature of the polymeric material so that a toy building element made of amorphous material is obtained. Typically, the temperature of the polymeric material in the barrel of the injection moulding machine is above the melting temperature. The melt enters the colder mold to solidify the material. The mold temperature can be above or below the glass transition temperature (Tg) 121041997.1 of the polymeric material. A temperature below the Tg favours a shift towards an amorphous end material.

It is well known that the impact toughness of the polymeric material needs to be at an adequate level in order to satisfy the requirements of product safety and play experience and so that long-lasting toy building bricks can be produced, which do not break when for example dropped on the floor or when stepped on by an adult person. Satisfactory impact toughness is particularly important for objects with complex geometries such as the geometry of a traditional LEGO® brick, which is provided with knobs on the upper side and/or complementary tubes on the lower side.

Some toy building elements are manufactured as construction bricks, i.e. the purpose of such bricks is to create larger, long-lasting constructions, which can be played with and moved from one place to another without the bricks falling apart. The coupling force, which indicates the effort that is required for a person to assemble and separate the bricks, is an important property for toy building elements. The coupling force is a result of the interconnected overlap between areas of the toy building elements, such as for example the knobs and complementary tubes. It is governed by e.g. material stiffness, friction, creep and stress relaxation. The coupling force is a very important property for construction bricks in order to maintain the functional durability of interconnected construction bricks in long-lasting constructions.

Unfortunately, the addition of impact modifier to the polymeric material impairs the stress relaxation property of the polymeric material, which is required to retain functional durability of the interconnected toy building elements in long-lasting constructions.

Therefore, there is a need to provide a polymeric material, which, on the one hand, possesses sufficiently high impact toughness and, on the other hand, also possesses satisfactory stress relaxation, so that toy building elements for use in long-lasting constructions can be produced.

The inventors of the present disclosure have overcome this challenge and are today capable of manufacturing toy building elements in impact modified amorphous polymeric material having satisfactory impact toughness combined with satisfactory functional durability, which makes it possible to create long-lasting constructions.

### SUMMARY

The present disclosure relates to a method for the manufacture of a toy building element with improved functional durability made of an impact modified amorphous material having an enthalpic relaxation of at least 0.3 J/g, such as in the range of 0.3 to 4 J/g and a shrinkage of maximum 0.2%. The present disclosure also relates to a toy building element with improved functional durability made of an impact modified amorphous material having an enthalpic relaxation of at least 0.3 J/g, such as in the range of 0.3 to 4 J/g and a shrinkage of maximum 0.2%.

The inventors of the present disclosure have surprisingly found that by heat treating toy building elements, toy building elements with improved functional durability are obtained, i.e. toy building elements having an enthalpic relaxation of at least 0.3 J/g, such as in the range of 0.3 to 4 J/g and a shrinkage of maximum 0.2% are obtained. This improved effect is seen when the toy building elements are heat treated at a treatment temperature of at least 40 degrees C. for a period of at least 15 minutes, where the upper limit of the heat treatment temperature is at most 20 degrees below the onset of glass transition temperature (Tg) of the impact modified amorphous material.

The toy building elements manufactured by the inventive method have an improved functional durability with an enthalpic relaxation of at least 0.3 J/g, such as in the range of 0.3 to 4.0 J/g and a shrinkage of maximum 0.2%. The improved functional durability makes it possible to assemble the toy building elements to create advanced and robust constructions with improved ability to stay assembled without the bricks breaking or losing their press fit function over time.

The improved functional durability also allows a longer lifetime of products reliant on their press fit function. This is both relevant for their stability when interconnected, but also their reusability. Moreover, the improved functional durability also allows certain press fits to have a stability in their function when assembling parts in pre-constructed assembly lines, to not require glue, welding or other methods of permanent interface assemblies. This is possible, as the immediate and press fit function over time is in control as a result of heat treating the toy building elements according to the present disclosure.

In a first aspect, the present disclosure relates to a method for the manufacture of a toy building element with improved functional durability made of an impact modified amorphous material having an enthalpic relaxation of at least 0.3 J/g, such as in the range of 0.3 to 4 J/g and a shrinkage of maximum 0.2%.

In a second aspect, the present disclosure relates to a toy building element with improved functional durability made of an impact modified amorphous material having an enthalpic relaxation of at least 0.3 J/g, such as in the range of 0.3 to 4 J/g and a shrinkage of maximum 0.2%.

### BRIEF DESCRIPTION OF THE DRAWINGS

FIG. 1 shows the stress relaxation measurement at 30 degrees C. and 1% strain for 48 hours of rPET containing 10 wt % PARALOID EXL and 2.5 wt % ELVALOY PTW with and without heat treatment of the injection moulded elements at 50 degrees C. for 8 hours.

FIG. 2 shows the normalized stress relaxation results from stress relaxation measurement at 30 degrees C. and 1% strain for 48 hours of rPET containing 10 wt % PARALOID EXL and 2.5 wt % ELVALOY PTW with and without heat treatment of the injection moulded elements at 50 degrees C. for 8 hours.

FIG. 3 shows the relative stress retention at 30 degrees C. and 1% strain for 48 hours of rPET containing 10 wt % PARALOID EXL and 2.5 wt % ELVALOY PTW with various heat treatment periods of the injection moulded elements at 50 degrees C.

FIG. 4 shows the relative stress retention at 30 degrees C. and 1% strain for 48 hours of impact modified PMMA, impact modified rPET, unmodified PETT and unmodified PETG materials from Table 1 with and without heat treatment of the injection moulded elements at 50 degrees C. or 60 degrees C. for 24 hours.

FIG. 5 shows the relative stress retention at 30 degrees C. and 1% strain for 48 hours of rPET containing various concentrations of impact modifier with and without heat treatment of the injection moulded elements at 50 degrees C. for 24 hours.

FIG. 6 shows the impact toughness of pure rPET and rPET containing various concentrations of impact modifier with and without heat treatment of the injection moulded elements at 50 degrees C. for 24 hours.

FIG. 7 shows the impact toughness and enthalpic relaxation of rPET containing 10 wt % PARALOID EXL and 2.5 wt % ELVALOY PTW during heat treatment of the injection moulded elements at 60 degrees C. for 24 hours.

FIG. 8 shows the percentage shrinkage of rPET containing 10 wt % PARALOID EXL and 2.5 wt % ELVALOY PTW after 24 hours of heat treatment of the injection moulded elements at various heat treatment temperatures.

FIG. 9 shows Charpy v-notch impact toughness of rPET containing 10 wt % PARALOID EXL and 2.5 wt % ELVALOY PTW after 24 hours of heat treatment of the injection moulded elements at various heat treatment temperatures.

FIG. 10 shows relative stress retention of rPET containing 10 wt % PARALOID EXL and 2.5 wt % ELVALOY PTW after 24 hours of heat treatment of the injection moulded elements at various heat treatment temperatures.

FIG. 11 shows a traditional box-shaped LEGO® 2*4 brick.

### DETAILED DESCRIPTION

A first aspect of the present disclosure relates to a method for the manufacture of a toy building element with improved functional durability made of an impact modified amorphous material having an enthalpic relaxation of at least 0.3 J/g, such as in the range of 0.3 to 4 J/g and a shrinkage of maximum 0.2%, said method comprising the steps of:
a) providing a resin comprising a polymer and an impact modifier,
b) processing the resin to produce the amorphous toy building element,
c) heat treating the amorphous toy building element at a heat treatment temperature of at least 40 degrees C. for a period of at least 15 minutes, and
d) cooling the heat treated toy building element to ambient temperature, wherein the upper limit of the heat treatment temperature in step c is 20 degrees C. below the onset of glass transition temperature (Tg) of the impact modified amorphous material.

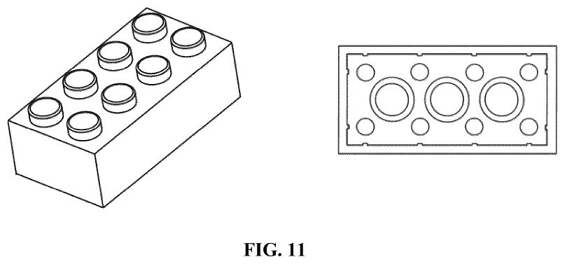

The term “toy building element” as used herein includes the traditional toy building elements in the form of box-shaped building bricks provided with knobs on the upper side and complementary tubes on the lower side. A traditional box-shaped toy building brick is shown in FIG. 11. The traditional box-shaped toy building bricks were disclosed for the first time in U.S. Pat. No. 3,005,282 and are widely sold under the tradenames LEGO® and LEGO® DUPLO®. The term also includes other similar box-shaped building bricks, which are produced by other companies than The LEGO Group and therefore sold under other trademarks than the trademark LEGO.

The term “toy building element” also includes other kinds of toy building elements provided with knobs on the upper side and/or complementary tubes on the lower side that may form part of a toy building set which typically comprises a plurality of building elements that are compatible with and hence can be interconnected with each other. Such toy building sets are also sold under the trademark LEGO, such as for example LEGO® bricks, LEGO® Technic and LEGO® DUPLO®. Some of these toy building sets includes toy building figures, such as for example LEGO® Minifigures (see for example U.S. Ser. No. 05/877,800), having complementary tubes on the lower side so that the figure can be connected to other toy building elements in the toy building set. Such toy building figures are also encompassed by the term “toy building element”. The term also includes similar toy building elements, which are produced by other companies than The LEGO Group and therefore sold under other trademarks than the trademark LEGO.

The toy building elements are available in a large variety of shapes, sizes and colours. One difference between LEGO® bricks and LEGO® DUPLO® bricks is the size in that a LEGO® DUPLO® brick is twice the size of a LEGO® brick in all dimensions. The size of the traditional box-shaped LEGO® toy building brick having 4*2 knobs on the upper side is about 3.2 cm in length, about 1.6 cm in width and about 0.96 cm in height (excluding knobs), and the diameter of each knob is about 0.48 cm. In contrast, the size of a LEGO® DUPLO® brick having 4*2 knobs on the upper side is about 6.4 cm in length, about 3.2 cm in width and about 1.92 cm in height (excluding knobs), and the diameter of each knob is about 0.96 cm.

The toy building elements manufactured by the method of the present disclosure have improved functional durability. The term “functional durability” as used herein refers to the stability, i.e. functional durability, of a material's stiffness during stress relaxation. In praxis, it can be seen as a measure of the coupling force. An acceptable functional durability would be 50% loss of stress during 48 hours at 35 degrees C. as measured in a 1% strain relaxation experiment. A preferred functional durability would be 20-50% loss of stress, and a particular preferred functional durability would be 20% or less loss of stress.

The toy building elements manufactured by the method of the present disclosure are made of an impact modified amorphous material. The term “impact modified material” refers to a polymeric material, in which the polymers are mixed with at least one impact modifier in such an amount that the impact toughness of the material is increased. The impact toughness is measured using the Charpy v-notch test according to ISO 179-1. An acceptable impact toughness of a durable material after heat treatment according to the present disclosure at 50 degrees C. for 24 hours is typically in the range of 5-100 KJ/m2. A preferred impact toughness is 8-50 KJ/m2, and a particular preferred impact toughness is 10-30 KJ/m2.

The term “enthalpic relaxation” as used herein refers to the integral of the endothermic peak after the onset of the glass transition temperature (Tg) measured by differential scanning calorimetry (DSC). This method is described in RSC. Advances, 2019, 9, 14209-14219 on s DSC autosampler (Q2000, TA Instruments, USA) on 20 mg flat cut-out sample.

The enthalpic relaxation must be at least 0.3 J/g. Typically, the enthalpic relaxation is in the range of 0.3 to 4 J/g, such as in the range of 0.5 to 4 J/g, but in a preferred embodiment the enthalpic relaxation is in the range of 1 to 3 J/g.

The term “shrinkage” as used herein refers to the average of the length and width of an ISO 527-1 BA tensile element, relative to the initial dimensions, according to the formula:

$$\% Shrinkage {( t = x )}_{avg} = ( 1 - \frac{( ( \frac{length ( t = x )}{length ( t = 0 )} ) + ( \frac{width ( t = x )}{width ( t = 0 )} ) )}{2} ) \cdot 100 \%$$

where t=x is the dimensions after some time of heat-treatment and t=0 are the initial dimensions of the element.

The toy building elements of the present disclosure is characterized by their functional durability, stress relaxation, enthalpic relaxation, shrinkage and impact toughness. It is important to understand the nature of these terms, including their relationship, in order to understand the disclosure.

Functional durability refers to the material's stiffness during stress relaxation, which is directly measured in a stress relaxation test. The stress relaxation greatly improves when subjecting the toy building elements to the heat treatment according to the present disclosure, by causing physical ageing. Impact toughness decreases as a result of physical ageing. This correlation is for example explained in RSC. Advances, 2019, 9, 14209-14219. Shrinkage is the measure of the dimensional stability of the toy building element. Finally, enthalpic relaxation measures the extent of physical ageing, which can be used to characterize any geometry, where stress relaxation and impact toughness tests require standardized geometries. This allows us to characterize the extent of physical ageing of any geometry, knowing their impact toughness and stress relaxation properties (see for example L. C. E. Struik, Physical aging in plastics and other glassy materials, Polym. Eng. Sci. 17 (3) (March 1977) 165-173).

The term “amorphous material” refers to a polymeric material that has a degree of crystallinity of 20% or less. The degree of crystallinity can be calculated using the formula:

$$\% crystallinity = [ ( Δ {H}_{f} - Δ {H}_{c} ) / Δ {H}_{f} ° ] * 100 \%$$

where the values ΔH_{f}, ΔH_{c} and ΔH_{f}^{o} are measured as described in “Kong, Y.; Hay, J. The measurement of the crystallinity of polymers by DSC, Polymer, 2002, 43, 3873-3878” on a DSC autosampler (Q2000, TA Instruments, USA) on 20 mg flat cut-out sample.

In step a) a resin is provided, which comprises a polymer and an impact modifier.

In one embodiment, the amount of polymer in the resin is at least 50 wt % based on the total weight of the resin. In other embodiments, the amount of polymer in the resin is at least 60 wt % based on the total weight of the resin. In preferred embodiments, the amount of polymer in the resin is at least 70 wt %, such as at least 85 wt % based on the total weight of the resin, or at least 90 wt % based on the total weight of the resin.

In another embodiment, the amount of polymer in the resin is in the range of 50-99 wt % based on the total weight of the resin. In other embodiments, the amount of polymer in the resin is in the range of 60-97 wt % or 70-95 wt % based on the total weight of the resin. In a preferred embodiment, the amount of polymer in the resin is in the range of 75-95 wt %, such as 80-95 wt % based on the total weight of the resin.

The polymer in the resin may be a bio-based polymer, a hybrid bio-based polymer or a petroleum-based polymer, or a mixture thereof.

By the term “bio-based polymer” as used herein is meant a polymer, which is produced by chemical, or biochemical polymerization of monomers derived from biomass. Bio-based polymers include polymers produced by polymerization of one type of monomer derived from biomass as well as polymers produced by polymerization of at least two different monomers derived from biomass.

In a preferred embodiment, the bio-based polymer is produced by chemical or biochemical polymerization of monomers, which are all derived from biomass.

Bio-based polymers according to the present disclosure include
Polymers produced by biochemical polymerization, i.e. for example by use of microorganisms. The monomers are produced using biomass as substrate.
Polymers produced by chemical polymerization, i.e. by chemical synthesis. The monomers are produced using biomass as substrate.

In some embodiments, the bio-based polymer is produced by biochemical polymerization. In other embodiments, the bio-based polymer is produced by chemical polymerization. In yet other embodiments, the bio-based polymers are produced by biochemical or chemical polymerization. The bio-based polymer may also be produced by a combination of biochemical and chemical polymerization, for example in cases where two monomers are combined to a dimer by a biochemical reaction path and then the dimers are polymerized by use of chemical reaction.

Bio-based polymers also include polymers having the same molecular structure as petroleum-based polymers, but which have been produced by chemical and/or biochemical polymerization of monomers derived from biomass.

By the term “petroleum-based polymers” as used herein is meant a polymer produced by chemical polymerization of monomers derived from petroleum, petroleum by-products or petroleum-derived feedstocks.

By the term “hybrid bio-based polymer” as used herein is meant a polymer, which is produced by polymerization of at least two different monomers, where at least one monomer is derived from biomass and at least one monomer is derived from petroleum, petroleum by-products or petroleum-derived feedstocks. The polymerization process is typically a chemical polymerization process.

The hybrid bio-based polymers may also be characterized by their content of bio-based carbon per total carbon content. The term “bio-based carbon” as used herein refers to the carbon atoms that originate from the biomass that is used as substrate in the production of monomers, which form part of the bio-based polymers and/or the hybrid bio-based polymers. The content of bio-based carbon in the hybrid bio-based polymer can be determined by Carbon-14 isotope content as specified in ASTM D6866 or CEN/TS 16137 or an equivalent protocol.

In some embodiments, the content of bio-based carbon in the hybrid bio-based polymer is at least 25% based on the total carbon content of the hybrid bio-based polymer, such as for example at least 30% or at least 40%. In other embodiments, the content of bio-based carbon in the hybrid bio-based polymer is at least 50% based on the total carbon content, such as at least 60% for example at least 70%, such as at least 80% based on the total carbon content of the hybrid bio-based polymer.

In some embodiments, the content of bio-based carbon in the polymer is at least 25% based on the total carbon content in the polymer. In other embodiments, the content of bio-based carbon in the polymer is at least 50% based on the total carbon content, such as at least 60% for example at least 70%, preferably at least 80%, more preferably at least 90%, even more preferably at least 95%. In the most preferred embodiment, the content of bio-based carbon in the polymer is 100% based on the total carbon content in the polymer.

In some embodiments, the content of bio-based carbon in the resin is at least 25% based on the total carbon content in the resin. In other embodiments, the content of bio-based carbon in the resin is at least 50% based on the total carbon content in the resin, such as at least 60% for example at least 70%, preferably at least 75%, more preferably at least 80%, even more preferably at least 85%. In the most preferred embodiment, the content of bio-based carbon in the resin is 90% based on the total carbon content in the resin.

The terms “bio-based polymer”, “hybrid bio-based polymer” and “petroleum-based polymer” also include recycled polymers and recycled material comprising “bio-based polymer”, “hybrid bio-based polymer” and “petroleum-based polymer”.

The term “recycled material” as used herein refers to a material, which is obtained by processing of a resin comprising recycled polymers. The recycled polymers are obtained from waste materials. The waste material can be mechanically recycled material or chemically recycled material.

“Mechanically recycled material” refers to material which has been recovered by mechanically recycling of material. Mechanical recycling involves only mechanical processes, such as for example grinding, washing, separating, drying, re-granulating and compounding. In a typical recycling process, the waste material is collected and washed in order to remove contaminants. The cleaned plastic is then grinded into flakes, which can be compounded and pelletized or reprocessed into granulate.

“Chemically recycled material” includes materials which has been obtained by pyrolysis, chemical depolymerisation, solvent dissolution or any other suitable chemical recycling process.

“Pyrolysis” refers to breakdown of the material to crude oil at elevated temperature in the absence of oxygen. New virgin-like polymers can then be made from the resulting oil by known polymerization processes.

“Chemical depolymerisation” refers to the process of breaking down of a polymer into either monomers, mixtures of monomers or intermediates thereof using a chemical agent. New virgin-like polymers can be produced by polymerization of the monomers.

“Solvent dissolution” refers to the selective extraction of polymers using solvents. The extracted polymers are recovered by precipitation of the polymer or by evaporation of the solvent. The polymer chain and structure is not broken down.

The term “recycled polymer” refers to the polymer comprised in the mechanically recycled waste material or the polymer, which is chemically recovered from the waste material in the solvent dissolution process. The term also refers to the virgin-like polymer, which is produced in the pyrolysis recycling process or the chemical depolymerisation recycling process. When the term refers to virgin-like polymers then it also includes polymers where only one or two of the monomers have been recycled by pyrolysis or chemical depolymerisation.

In some embodiments, the resin comprises mechanically recycled polymers. In other embodiments, the resin comprises mechanically recycled polymers and bio-based polymers. In other embodiments, the resin comprises mechanically recycled polymers and hybrid bio-based polymers. In yet other embodiments, the resin comprises mechanically recycled polymers and petroleum-based polymers. In still other embodiments, the resin comprises mechanically recycled polymers, bio-based polymers and petroleum-based polymers. In still other embodiments, the resin comprises mechanically recycled polymers, hybrid bio-based polymers and petroleum-based polymers. In yet other embodiments, the resin comprises mechanically recycled polymers, bio-based polymers and hybrid bio-based polymers. And in other embodiments, the resin comprises mechanically recycled polymers, bio-based polymers, hybrid bio-based polymers and petroleum-based polymers.

In some embodiments, the amount of mechanically recycled polymers in the resin is at least 10 wt % based on the total weight of the resin, such as at least 20 wt %, or for example at least 30 wt %, such as at least 40 wt % or for example at least 50 wt %. In other embodiments, the amount of mechanically recycled polymers in the resin is at least 60 wt % based on the total weight of the resin, such as at least 70 wt %, or for example at least 75 wt %, such as at least 80 wt % or for example at least 85 wt %.

In some embodiments, the polymer comprises chemically recycled monomers. In other embodiments, the polymer comprises chemically recycled monomers and bio-based monomers. In other embodiments, the polymer comprises chemically recycled monomers and hybrid bio-based monomers. In yet other embodiments, the polymer comprises chemically recycled monomers and petroleum-based monomers. In still other embodiments, the polymer comprises chemically recycled monomers, bio-based monomers and petroleum-based monomers. In still other embodiments, the polymer comprises chemically recycled monomers, hybrid bio-based monomers and petroleum-based monomers. In yet other embodiments, the polymer comprises chemically recycled monomers, bio-based monomers and hybrid bio-based monomers. And in other embodiments, the polymer comprises chemically recycled monomers, bio-based monomers, hybrid bio-based monomers and petroleum-based monomers.

In some embodiments, the amount of chemically recycled monomers in the polymer is at least 10 wt % based on the total weight of the polymer, such as at least 20 wt %, or for example at least 30 wt %, such as at least 40 wt % or for example at least 50 wt %. In other embodiments, the amount of chemically recycled monomers in the polymer is at least 60 wt % based on the total weight of the polymer, such as at least 70 wt %, or for example at least 80 wt %, such as at least 90 wt % or for example at least 95 wt %.

In a preferred embodiment, the polymer is selected from the group consisting of polyesters, polyacrylates and polystyrenes.

In one embodiment, the polymer in the resin is polyester. The term “polyester” as used herein includes any polymer, in which the monomers are bonded via ester linkages. In particular, the term includes PET polyesters and modified PET polyesters and mixtures thereof.

The term “PET polyester” as used herein includes any polymer produced by polymerization of the monomers ethylene glycol and terephthalic acid.

The term “modified PET polyester” as used herein includes any PET polyester in which either the terephthalic acid monomer or the ethylene glycol monomer has been replaced with another diacid monomer or diol monomer, respectively. In particular, the modified PET polyester has been modified by replacing
all or parts of the terephthalic acid groups of the PET polyester with a diacid monomer selected from the group consisting of adipic acid, succinic acid, isophthalic acid, furandicarboxylic acid, phthalic acid, 4,4′-biphenyl dicarboxylic acid, 2,6-naphthalenedicarboxylic acid and mixtures thereof; and/or
all or parts of the ethylene glycol groups of the PET polyester with a diol monomer selected from the group consisting of isosorbide, 1,4-cyclohexanedimethanol, 2,2,4,4-tetramehyl-1,3-cyclobutanediol, diethylene glycol, 1,2-propanediol, neopentylene glycol, 1,3-propanediol, 1,4 butanediol and mixtures thereof,
   with the proviso that not all of the terephthalic acid groups and all of the ethylene glycol groups can be replaced at the same time.

The PET polyester is produced by polymerization of the monomers ethylene glycol and terephthalic acid. The modified PET polyester may be produced in three different ways. First of all, the modified PET polyester may be produced by polymerization of the monomers ethylene glycol, terephthalic acid and one or more further comonomer(s), which is/are a diacid monomer and/or a diol monomer thereby producing a diacid modification, a diol modification or a diacid/diol modification. Secondly, the modified PET polyester may be produced by polymerization of the monomer ethylene glycol and one or more further comonomer(s), which is/are one or more diacid monomer(s) and optionally one or more diol monomer(s). Thirdly, the modified PET polyester may be produced by polymerization of the monomer terephthalic acid and one or more further comonomer(s), which is/are one or more diol monomer(s) and optionally one or more diacid monomer(s). In all cases the diacid monomer is selected from the group consisting of adipic acid, succinic acid, isophthalic acid, furandicarboxylic acid, phthalic acid, 4,4′-biphenyl dicarboxylic acid, 2,6-naphthalenedicarboxylic acid and mixtures thereof and the diol monomer is selected from the group consisting of isosorbide, 1,4-cyclohexanedimethanol, 2,2,4,4-tetramehyl-1,3-cyclobutanediol, diethylene glycol, 1,2-propanediol, neopentylene glycol, 1,3-propanediol, 1,4 butanediol and mixtures thereof.

In some embodiments, the polymer in the resin is PET polyester. The PET polyester is produced by reaction of ethylene glycol and terephthalic acid. In a preferred embodiment, the polyester is PET polyester.

In some embodiments, the polymer in the resin is a modified PET polyester, which has been produced by reaction of ethylene glycol and terephthalic acid and the comonomer 1,4-cyclohexanedimethanol. In other embodiments, the polymer in the resin is a modified PET polyester, which has been produced by reaction of ethylene glycol and terephthalic acid and the comonomer isophthalic acid. In other embodiments, the polymer in the resin is a modified PET polyester which has been produced by reaction of ethylene glycol and terephthalic acid and the comonomer 2,2,4,4-tetramehyl-1,3-cyclobutanediol. In other embodiments, the polymer in the resin is a modified PET polyester which has been produced by reaction of terephthalic acid and 1,4-cyclohexanedimethanol. In yet other embodiments, the polymer in the resin is a modified PET polyester, which has been produced by reaction of terephthalic acid, isophthalic acid and 1,4-cyclohexanedimethanol. In other embodiments, the polymer in the resin is a modified PET polyester, which has been produced by reaction of ethylene glycol, terephthalic acid, and 2,5-furandicarboxylic acid.

In preferred embodiments, the polymer in the resin is poly(ethylene terephthalate-co-isophthalate) polyester. The poly(ethylene terephthalate-co-isophthalate) polyester is produced by reaction of ethylene glycol, terephthalic acid and isophthalic acid. In a preferred embodiment, the polymer in the resin is a modified PET polyester, which is poly(ethylene terephthalate-co-isophthalate) polyesters. The amount of isophthalic acid in the poly(ethylene terephthalate-co-isophthalate) polyesters is typically 0.5-12 mol % and preferably 1-3 mol %.

The chemical composition of poly(ethylene terephthalate-co-isophthalate) polyesters, i.e. the amount of isophthalic acid in the poly(terephthalate-co-isophthalate) polyester, may be characterised by 13C Nuclear Magnetic Resonance spectroscopy (C NMR) according to the method described in “Martínez de Ilarduya, A.; Kint, D. P.; Muñoz-Guerra, S. Sequence Analysis of Poly (ethylene terephthalate-co-isophthalate) Copolymers by 13C NMR. Macromolecules 2000, 33, 4596-4598”. Accordingly, the amount of isophthalic acid may be measured using this C NMR method.

An important characteristic of PET is the intrinsic viscosity (IV). The intrinsic viscosity, which is measured in dl/g, is found by extrapolating the relative viscosity to zero concentration. It depends on the length of the PET polymer chains. The longer the polymer chains the more entanglements between chains and therefore the higher the viscosity. The average length of a particular batch of PET resin can be controlled during the polymerization process. The PET Intrinsic Viscosity (IV) may be measured according to ASTM D4603.

High IV homo- and copolymer PET compositions are difficult to process in injection moulding due to their high viscosity.

In some embodiments, the IV of the PET polyester ranges from 0.6-1.1 dl/g, such as 0.7-0.9 dl/g, preferably from 0.75-0.85 dl/g.

In preferred embodiments, the modified PET polyester is PET of bottle grade. The term “bottle grade” is well known in the technical area and refers to PET starting materials that can easily be processed into bottles. In most embodiments, the “bottle grade” PET is made of poly(ethylene terephthalate-co-isophthalate) polyesters comprising 1-3 mol % of isophthalic acid. In bottle grade PET the IV is typically in the range of 0.70-0.78 dl/g for non-carbonated water, and in the range of 0.78-0.85 for carbonated water.

Suitable examples of PET grades which are also commercial available include bottle grade EASTLON PET CB-600, CB-602 and CB-608 supplied by Far Eastern New Century (FENC), commercial grade post-consumer rPET CB-602R supplied by FENC, partially bio-based bottle grade PET CB-602AB supplied by FENC and homopolymer PET grade 6020 supplied by Invista.

In some embodiments, the polymer in the resin is a modified PET polyester, which has been produced by reaction of ethylene glycol and terephthalic acid and the comonomer 1,4-cyclohexanedimethanol. In some embodiments, the polymer in the resin is poly(ethylene glycol-co-1,4-cyclohexanedimethanol terephthalate) polyesters, also referred to as glycol modified polyethylene terephthalate or PETG. In a preferred embodiment, the polyester is a modified PET polyester, which is PETG. The amount of 1,4-cyclohexanedimethanol in the PETG is typically 0.1-25 mol %. In other embodiments, the polymer in the resin is ethylene glycol modified poly(cyclohexylenedimethylene terephthalate) also referred to as PCTG. In a preferred embodiment, the polyester is a modified PET polyester, which is PETG. The amount of 1,4-cyclohexanedimethanol in the PETG is typically 25-49.99 mol %.

In other embodiments, the polymer in the resin is a modified PET polyester which has been produced by reaction of ethylene glycol and terephthalic acid and the comonomer 2,2,4,4-tetramehyl-1,3-cyclobutanediol. In some embodiments, the polymer in the resin is poly(ethylene glycol-co-2,2,4,4-tetramethyl-1,3-cyclobutanediol terephthalate) also referred to as PETT.

In other embodiments, the polymer in the resin is a modified PET polyester which has been produced by reaction of terephthalic acid and 1,4-cyclohexanedimethanol. In some embodiments, the polymer in the resin is poly(cyclohexanedimethylene terephthalate) also referred to as PCT.

In yet other embodiments, the polymer in the resin is a modified PET polyester, which has been produced by reaction of terephthalic acid, isophthalic acid and 1,4-cyclohexanedimethanol. In some embodiments, the polymer in the resin is isophthalic acid modified poly(cyclohexanedimethylene terephthalate) also referred to as PCTA. The amount of isophthalic acid is typically 0.1-50 mol %, more typically 0.1-5 mol %.

In some embodiments, the polymer in the resin is poly(ethylene furanoate-co-ethylene terephthalate) polyester. The poly(ethylene furanoate-co-ethylene terephthalate) polyester is produced by reaction of ethylene glycol, terephthalic acid and 2,5-furandicarboxylic acid. The amount of 2,5-furandicarboxylic acid in the modified PET polyester is typically 0.5-12 mol % and preferably 1-3 mol %.

In some embodiments, the polymer in the resin is poly(ethylene furanoate) polyester, also referred to as PEF. The poly(ethylene furanoate) polyester is produced by reaction of ethylene glycol and furandicarboxylic acid. In a preferred embodiment, the polyester is a modified PET polyester, which is PEF.

In one embodiment, the polymer in the resin is polyacrylate. The term “polyacrylate” as used herein includes any polymer produced by polymerization of acrylate monomers, such as acrylic acid, alkyl substituted acrylic acid, or its esters or salts.

Preferred acrylate monomers include acrylic acid, methyl acrylate, ethyl acrylate, propyl acrylate, methyl methacrylate, methyl ethyl acrylate and ethyl methacrylate.

In a preferred embodiment, the polyacrylate may be selected from the group consisting of poly(acrylic acid), poly(methyl acrylate), poly(ethyl acrylate), poly(propyl acrylate), poly(methyl methacrylate) and poly(ethyl methacrylate). In a particular preferred embodiment, the polyacrylate is poly(methyl methacrylate) (PMMA).

In one embodiment, the polymer in the resin is polystyrenes. The term “polystyrene” as used herein includes polymers made by polymerization of the monomer styrene. The term also include copolymers made by co-polymerization of the monomer styrene with one or more monomer(s) selected from the group consisting of butadiene, ethylene and acrylonitrile. Accordingly, the term includes acrylonitrile butadiene styrene (ABS), which is made from poly(styrene acrylonitrile), also known as SAN, which is emulsion or mass polymerized with polybutadiene, whereby the polybutadiene is effectively encapsulated or dispersed in the SAN matrix. In a preferred embodiment, the polystyrene is selected from the group consisting of poly(styrene acrylonitrile) (SAN), styrene butadiene copolymer and acrylonitrile butadiene styrene (ABS). Styrene butadiene copolymer includes block copolymers, such as styrene-butadiene copolymers, styrene-butadiene-styrene copolymers (SBS), butadiene block copolymer (SBC) and styrene-ethylene-butylene-styrene copolymers (SEBS).

In a preferred embodiment, the polymer is selected from the group consisting of polyethylene terephthalate (PET), poly(ethylene glycol-co-2,2,4,4-tetramethyl-1,3-cyclobutanediol terephthalate) (PETT), poly(ethylene glycol-co-1,4-cyclohexanedimethanol terephthalate) (PETG) and poly(methyl methacrylate) (PMMA). In an even more preferred embodiment, the polymer is selected from the group consisting of polyethylene terephthalate (PET) polyester and poly(methyl methacrylate) (PMMA).

The resin also comprises an impact modifier. By the term “impact modifier” as used herein is meant an agent that increases the impact toughness of the produced toy building element. The impact toughness is measured using the Charpy v-notch test according to ISO 179-1.

The impact modifier can be a reactive impact modifier, a non-reactive impact modifier or a mixture thereof.

By the term “reactive impact modifier” as used herein is meant an impact modifier having functionalized end groups. These functionalized end groups serve two purposes: 1) to bond the impact modifier to the polymer matrix and 2) to modify the interfacial energy between the polymer matrix and the impact modifier for enhanced dispersion. Preferred examples of such functionalized end groups include glycidyl methacrylates, maleic anhydrides and carboxylic acids.

In a preferred embodiment, the reactive impact modifier is a copolymer of the formula X/Y/Z where X is aliphatic or aromatic hydrocarbon polymer having 2-8 carbon atoms, Y is a moiety comprising an acrylate or methacrylate having 3-6 and 4-8 carbon atoms, respectively, and Z is a moiety comprising methacrylic acid, glycidyl methacrylate, maleic anhydride or carboxylic acid.

In one preferred embodiment, the reactive impact modifier may be described by the formula:

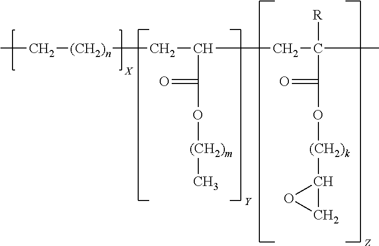

where
n is an integer from 1 to 4,
m is an integer from 0 to 5,
k is an integer from 0 to 5, and
R is an alkyl of 1 to 5 carbon or 1 hydrogen atom.
X constitutes 40-90 wt % of the impact modifier, and Y constitutes 0-50 wt %, such as 10-40 wt %, preferably 15-35 wt %, most preferably 20-35 wt % of the impact modifier, and Z constitutes 0.5-20 wt %, preferably 2-10 wt %, most preferably 3-8 wt % of the reactive impact modifier.

In other embodiments, X constitutes 70-99.5 wt % of the reactive impact modifier, preferably 80-95 wt %, most preferably 92-97 wt % and Y constitutes 0 wt % of the impact modifier, and Z constitutes 0.5-30 wt %, preferably 5-20 wt %, most preferably 3-8 wt % of the reactive impact modifier.

Suitable examples of specific reactive impact modifiers that can be used in the resin of the present disclosure include ethylene-ethylene acrylate-glycidyl methacrylate and ethylene-butyl acrylate-glycidyl methacrylate. Commercial available impact modifiers include Paraloid™ EXM-2314 (an acrylic copolymer from Dow Chemical Company), Lotader® AX8700, Lotader® AX8900, Lotader AX8750®, Lotader® AX8950 and Lotader® AX8840 (manufactured by Arkema) and Elvaloy® PTW (manufactured by DuPont).

Other suitable examples of specific reactive impact modifiers that can be used in the resin of the present disclosure include anhydride modified ethylene acrylates. Commercial available impact modifiers include Lotader® 3210, Lotader® 3410, Lotader® 4210, Lotader® 3430, Lotader® 4402, Lotader® 4503, Lotader® 4613, Lotader® 4700, Lotader® 5500, Lotader® 6200, Lotader® 8200, Lotader® HX8210, Lotader® HX8290, Lotader® LX4110, Lotader® TX8030 (manufactured by Arkema), Bynel® 21E533, Bynel® 21E781, Bynel® 21E810 and Bynel® 21E830 (manufactured by DuPont).

In other embodiments, the reactive impact modifier is a modified ethylene vinyl acetate, such as for example Bynel® 1123 or Bynel® 1124 (manufactured by DuPont), an acid modified ethylene acrylate, such as for example Bynel® 2002 or Bynel® 2022 (manufactured by DuPont), a modified ethylene acrylate, such as for example Bynel® 22E757, Bynel® 22E780 or Bynel® 22E804 (manufactured by DuPont), an anhydride modified ethylene vinyl acetate, such as for example Bynel® 30E670, Bynel® 30E671, Bynel® 30E753 or Bynel® 30E783 (manufactured by DuPont), and acid/acrylate modified ethylene vinyl acetate, such as for example Bynel® 3101 or Bynel® 3126 (manufactured by DuPont), an anhydride modified ethylene vinyl acetate, such as for example Bynel® E418, Bynel® 3810, Bynel® 3859, Bynel® 3860 or Bynel® 3861 (manufactured by DuPont), an anhydride modified ethylene vinyl acetate, such as for example Bynel® 3930 or Bynel® 39E660 (manufactured by DuPont), and anhydride modified high density polyethylene, such as for example Bynel® 4033 or Bynel® 40E529 (manufactured by DuPont), an anhydride modified linear low density polyethylene, such as for example Bynel® 4104, Bynel® 4105, Bynel® 4109, Bynel® 4125, Bynel® 4140, Bynel® 4157, Bynel® 4164, Bynel® 41E556, Bynel® 41E687, Bynel® 41E710, Bynel® 41E754, Bynel® 41E755, Bynel® 41E762, Bynel® 41E766, Bynel® 41E850, Bynel® 41E865 or Bynel® 41E871 (manufactured by DuPont) an anhydride modified low density polyethylene, such as for example Bynel® 4206, Bynel® 4208, Bynel® 4288 or Bynel® 42E703 (manufactured by DuPont) or an anhydride modified polypropylene, such as for example Bynel® 50E571, Bynel® 50E662, Bynel® 50E725, Bynel® 50E739, Bynel® 50E803 or Bynel® 50E806 (manufactured by DuPont).

Other suitable reactive impact modifiers include maleic anhydride grafted impact modifiers. Specific examples of such reactive impact modifiers include chemically modified ethylene acrylate copolymers, such as Fusabond® A560 (manufactured by DuPont), an anhydride modified polyethylene, such as Fusabond® E158 (manufactured by DuPont), an anhydride modified polyethylene resin, such as for example Fusabond® E564 or Fusabond® E589 or Fusabond® E226 or Fusabond® E528 (manufactured by DuPont), an anhydride modified high density polyethylene, such as for example Fusabond® E100 or Fusabond® E265 (manufactured by DuPont), an anhydride modified ethylene copolymer, such as for example Fusabond® N525 (manufactured by DuPont), or a chemically modified propylene copolymer, such as for example Fusabond® E353 (manufactured by DuPont).

Yet other suitable reactive impact modifiers include ethylene-acid copolymer resins, such as ethylene-methacrylic acid (EMAA) based copolymers and ethylene-acrylic acid (EAA) based copolymers. Specific examples of ethylene-methacrylic acid based copolymer impact modifiers include Nucrel® 403, Nucrel® 407HS, Nucrel® 411HS, Nucrel® 0609HSA, Nucrel® 0903, Nucrel® 0903HC, Nucrel® 908HS, Nucrel® 910, Nucrel® 910HS, Nucrel® 1202HC, Nucrel® 599, Nucrel® 699, Nucrel® 925 and Nucrel® 960 (manufactured by DuPont). Specific examples of ethylene-acrylic acid based copolymers Nucrel® 30707, Nucrel® 30907, Nucrel® 31001, Nucrel® 3990 and Nucrel® AE (manufactured by DuPont). Other specific examples of ethylene of ethylene-acrylic acid (EAA) based copolymers include Escor™ 5000, Escor™ 5020, Escor™ 5050, Escor™ 5080, Escor™ 5100, Escor™ 5200 and Escor™ 6000 (manufactured by ExonMobile Chemical).

Still other suitable reactive impact modifiers include ionomers of ethylene acid copolymers. Specific examples of such impact modifiers include Surlyn® 1601, Surlyn® 1601-2, Surlyn® 1601-2 LM, Surlyn® 1605, Surlyn® 8150, Surlyn® 8320, Surlyn® 8528 and Surlyn® 8660 (manufactured by DuPont).

In other embodiments, the reactive impact modifier is an alkyl methacrylate-silicone/alkyl acrylate graft copolymer. The “alkyl methacrylate” of the graft copolymer may be one selected from the group consisting of methyl methacrylate, ethyl methacrylate, propyl methacrylate, isopropyl methacrylate and butyl methacrylate. The “silicone/alkyl acrylate” in the graft copolymer refers to a polymer obtained by polymerizing a mixture of a silicone monomer and an alkyl acrylate monomer. The silicone monomer may be selected from the group consisting of dimethylsiloxane, hexamethylcyclotrisiloxane, octamethylcyclotetrasiloxane, decamethylcyclopentasiloxane, dodecamethylcyclohexasiloxane, trimethyltriphenylcyclotetrasiloxane, tetramethyltetraphenylcyclotetrasiloxane and octaphenylcyclotetrasiloxane. The alkyl monomer may be selected from the group consisting of methyl methacrylate, ethyl methacrylate, propyl methacrylate, isopropyl methacrylate, butyl methacrylate and butyl methacrylate. The graft copolymer is in the form of core-shell rubber and has a graft rate of 5 to 90 wt %, a glass transition temperature of the core of −150 to −20 degrees C., and a glass transition temperature of the shell of 20 to 200 degrees C. In one embodiment, of the present disclosure, the graft copolymer is methyl methacrylate-silicone/butyl acrylate graft copolymer. Specific examples include S-2001, S-2100, S-2200 and S-2501 manufactured by Mitsubishi Rayon Co., Ltd. In Japan.

Other suitable reactive impact modifiers include the siloxane polymers mentioned in U.S. Pat. No. 4,616,064, which contain siloxane units, and at least one of carbonate, urethane or amide units.

Suitable reactive and non-reactive impact modifiers also include those mentioned in WO 2018/089573 paragraphs [0043]-[0072].

By the term “non-reactive impact modifier” as used herein is meant an impact modifier, which does not have functionalized end groups and therefore cannot form covalent chemical bonds with the polymer matrix. The non-reactive impact modifiers are typically dispersed into the polymer matrix by intensive compounding but may coalesce downstream in the compounder.

Non-reactive impact modifiers may take a unique core-shell structure. This structure is obtained by copolymerization of a hard shell around a soft rubber core and since the structure is typically obtained by emulsion copolymerization, it provides a well-defined particle size, which in turn leads to a well-controlled blend morphology.

Suitable examples of non-reactive core-shell impact modifiers include those mentioned in U.S. Pat. No. 5,409,967, i.e. core-shell impact modifiers with a core comprised mainly of a rubbery core polymer such as a copolymer containing a diolefin, preferably a 1,3-diene, and a shell polymer comprised mainly of a vinyl aromatic monomer, such as styrene, and hydroxylalkyl (meth)acrylate or, in the alternative, another functional monomer which acts in a manner similar to the hydroxylalkyl (meth)acrylate. Other suitable examples include impact modifiers with a soft rubber-core, such as for example a butadiene core, an acrylic core or a silicone-acrylic core, and a shell made of polymethyl (methacrylate) (PMMA).

In some embodiments, the reactive impact modifier has a functionalized end group, which is selected from the group consisting of glycidyl methacrylate, maleic anhydride and carboxylic acid. In a preferred embodiment, the functionalized group of the reactive impact modifier is glycidyl methacrylate.

In some embodiments, the reactive impact modifier has a functionalized end group, which is selected from the group consisting of glycidyl methacrylate, maleic anhydride and carboxylic acid, and the non-reactive impact modifier is a core shell impact modifier. In a preferred embodiment, the reactive impact modifier has a functionalized end group, which is glycidyl methacrylate, and the non-reactive impact modifier is a core shell impact modifier.

In some embodiments, the non-reactive impact modifier is a core shell impact modifier. In a preferred embodiment, the non-reactive impact modifier is a core shell impact modifier with a butadiene core, an acrylic core or a silicone-acrylic core, and a shell made of polymethyl (methacrylate) (PMMA).

In some embodiments, the reactive impact modifier has a functionalized end group, which is selected from the group consisting of glycidyl methacrylate, maleic anhydride and carboxylic acid, and the non-reactive impact modifier is an ethylene-acrylate co-polymer. In a preferred embodiment, the reactive impact modifier has a functionalized end group, which is glycidyl methacrylate, and the non-reactive impact modifier is an ethylene-acrylate co-polymer.

In some embodiments, the total amount of impact modifier in the resin is in the range of 1-30 wt % based on the total weight of the resin. In some embodiments, the total amount of impact modifier is in the range of 2-25 wt %, more preferred 3-20 wt % or 4-15 wt % or even more preferred 5-15 wt % based on the total weight of the resin.

In one embodiment, the resin does not contain glass, glass beads and/or glass fibres. In one embodiment, the resin does not contain fibres. In one embodiment, the resin does not contain inorganic reinforcements, such as aluminum silicate, asbestos, talc, mica and calcium carbonate. In one embodiment, the resin does not contain organic reinforcements, such as aramid fibres, carbon nanotubes, graphene and graphite. In one embodiment, the resin does not contain glass and fibres.

In one embodiment, the resin further comprises one or more filler(s) in an amount of up to 5 wt % based on the total weight of the resin, such as from 0.1-5 wt %, more preferred from 0.2-4 wt %, most preferred from 0.5-3 wt %. The one or more filler(s) may be inorganic particulate material or a nanocomposite or a mixture thereof.

Suitable examples of inorganic particulate material include inorganic oxides, such as glass, MgO, SiO2, TiO2 and Sb2O3; hydroxides, such as Al(OH)3 and Mg(OH)2; salts, such as CaCO3, BaSO4, CaSO4 and phosphates; silicates, such as talc, mica, kaolin, wollastonite, montmorillonite, nanoclay, feldspar and asbestos; metals, such as boron and steel; carbon-graphite, such as carbon fibers, graphite fibers and flakes, carbon nanotubes and carbon black. Suitable examples of inorganic particulate material also include surface treated and/or surface modified SiO2 and TiO2, such as for example alumina surface modified TiO2.

Suitable examples of nanocomposites include clay filled polymers, such as clay/low density polyethylene (LDPE) nanocomposites, clay/high density polyethylene (HDPE) nanocomposites, acrylonitrile-butadiene-styrene (ABS)/clay nanocomposites, polyimide (PI)/clay nanocomposites, epoxy/clay nanocomposites, polypropylene (PP)/clay nanocomposites, poly (methyl methacrylate) (PMMA)/clay nanocomposites and polyvinyl chloride (PVC)/clay nanocomposites; alumina filled polymers, such as epoxy/alumina nanocomposites, PMMA/alumina nanocomposites, PI/alumina nanocomposites, PP/alumina nanocomposites, LDPE/alumina nanocomposites and cross-linked polyethylene (XLPE)/alumina nanocomposites; barium titanate filled polymers, such as HDPE/barium titanate nanocomposites and polyetherimide (PEI)/barium titanate nanocomposites; silica filled polymers, such as PP/silica nanocomposites, epoxy/silica nanocomposites, PVC/silica nanocomposites, PEI/silica nanocomposites, PI/silica nanocomposites, ABS/silica nanocomposites, and PMMA/silica nanocomposites; and zinc oxide filled polymers, such as LDPE/zinc oxide nanocomposites, PP/zinc oxide nanocomposites, epoxy/zinc oxide nanocomposites and PMMA/zinc oxide nanocomposites.

In step b), the resin is processed to produce the amorphous toy building elements. The amorphous toy building element may be manufactured by injection moulding the resin, extruding the resin or by additively manufacturing the resin. The preferred type of processing is injection moulding. The toy building element can also be manufactured by a combination of injection moulding and additive manufacturing, where an injection moulded toy building element is further processed by additively manufacturing further parts of the toy building element on top of the injection moulded toy building element (see for example US 2015/0190724 A1)

In some embodiments, the toy building element is manufactured by injection moulding.

In such embodiments, the impact modifier is mixed with the polymers during feeding of the injection moulding machine.

In other embodiments, the impact modifier is mixed with the polymer prior to feeding the mixture to the injection moulding machine. The mixing may be performed by dry mixing or by compounding.

In some embodiments, the impact modifier and the polymer are dry mixed prior to feeding of the injection moulding machine.

In other embodiments, the impact modifier and the polymer are mixed by compounding prior to feeding it to the injection moulding machine.

In some embodiments, the impact modifier and the polymer are compounded by thoroughly mixing to ensure sufficient dispersion and then fed directly into the injection moulding machine.

In other embodiments, the polymer and the impact modifier may be mixed into a masterbatch, which is then mixed with the rest of the resin during feeding of the injection moulding machine.

Additives, such as fillers, nucleating agents, anti-hydrolysis additives, release agents, lubricants, UV stabilizers, flame retardants, chain extenders processing stabilizers, antioxidants and colouring agents or pigments, may be added and mixed with the impact modifiers and the polyester either prior to or during feeding to the injection moulding machine.

The injection moulded toy building element is made of an amorphous material. A skilled person is aware how to control the injection moulding process so that an injection moulded article in amorphous material is obtained. Typically, the temperature of the polymeric material in the barrel of the injection moulding machine is above the melting temperature. The melt enters the colder mold to solidify the material. The mold temperature can be above or below the glass transition temperature (Tg) of the polymeric material. A temperature below the Tg favours a shift towards an amorphous end material. A skilled person knows that the faster cooling rate of the injected material the more amorphous material is obtained. A fast cooling rate is typically obtained by keeping the mold temperature as low as possible and preferably markedly below the glass transition temperature of the injected material.

In step c), the amorphous toy building element is heat treated at a heat treatment temperature of at least 40 degrees C. for a period of at least 15 minutes. The upper limit of the heat treatment temperature is 20 degrees below the onset of glass transition temperature (Tg) of the impact modified amorphous material.

Unlike annealing, heat treatment according to the present disclosure is performed under the glass transition temperature of a material. This is important because heat treating the material at or above the glass transition temperature has no influence on the functional durability and enthalpic relaxation. The temperature difference between the onset of the glass transition temperature and the heat treatment temperature according to the present disclosure is to avoid warpage and in-moulded stress release of the amorphous elements from the heat treatment. The rate of functional durability improvement is related to the difference between the exposed heat treatment temperature and the glass transition temperature of the heat treated material. The rate of functional durability improvement of a material is increased by being closer to the glass transition temperature of the heat treated material.

The term “glass transition temperature”, Tg, as used herein refers to the temperature at which a hard glassy state of an amorphous material is converted into a rubbery state. This conversion typically occurs over a temperature range. Therefore, the term “onset of glass transition temperature” as used herein refers to the temperature at which conversion process begins.

The onset of glass transition temperature depends on the particular polymeric material. For example PET has an onset of Tg of about 80 degrees C., PETG has an onset of Tg of about 80 degrees C., PETT has an onset of Tg of about 90 degrees C., PCTT has an onset of Tg of about 110 degrees C. and the SAN phase in ABS has an onset of Tg of about 100 degrees C.

In some embodiments, the upper limit of the heat treatment temperature is in the range of 20-45 degrees C. below the onset of glass transition temperature (Tg), such as in the range of 20-40 degrees C. below the onset of glass transition temperature (Tg), or in the range of 25-35 degrees C. below the onset of glass transition temperature (Tg), provided that the lower limit of the heat treatment temperature is 40 degrees C. or above. In a preferred embodiment, the upper limit of the heat treatment temperature is 30 degrees C. below the onset of glass transition temperature (Tg).

In an embodiment, the heat treatment temperature is at least 42 degrees C., such as at least 44 degrees C., or at least 46 degrees C., or at least 48 degrees C. or at least 50 degrees C.

The heat treatment period is at least 15 minutes. In theory, there is no upper limit for the heat treatment period. Typically, the amorphous toy building elements are heat treated in a period of 15 minutes to 672 hours (4 weeks), such as in a period of 1 hour to 168 hours (1 week) or 1 hour to 24 hour. In preferred embodiments, the amorphous toy building elements are heat treated in a period of 1 to 12 hours, more preferred 4 to 10 hours, and most preferred 8 hours.

In step d), the heat treated toy building element is cooled to ambient temperature. This cooling can be done by storing the elements at ambient conditions or actively cooling them down to a temperature lower than ambient conditions. This can be done in ambient atmosphere or water to reduce the time until ambient temperature of the element is reached. Once the ambient temperature has been reached the toy building elements can be packed and stored or the toy building elements can be sent to stores for sale.

A second aspect of the present disclosure relates to a toy building element with improved functional durability made of an impact modified amorphous material comprising a polymer and an impact modifier and having an enthalpic relaxation of at least 0.3 J/g, such as in the range of 0.3 to 4 J/g and a shrinkage of maximum 0.2%.

In a preferred embodiment, the toy building element is manufactured by the method according to the present disclosure.

The amount of polymer in the impact modified amorphous material is preferably at least 50 wt % based on total weight of the impact modified amorphous material.

In other embodiments, the amount of polymer in the impact modified amorphous material is at least 60 wt % based on the total weight of the impact modified amorphous material. In preferred embodiments, the amount of polymer in the impact modified amorphous material is at least 70 wt %, such as at least 85 wt % based on the total weight of the impact modified amorphous material, or at least 90 wt % based on the total weight of the impact modified amorphous material.

In another embodiment, the amount of polymer in the impact modified amorphous material is in the range of 50-99 wt % based on the total weight of the impact modified amorphous material. In other embodiments, the amount of polymer in the impact modified amorphous material is in the range of 60-97 wt % or 70-95 wt % based on the total weight of the impact modified amorphous material. In a preferred embodiment, the amount of polymer in the impact modified amorphous material is in the range of 75-95 wt %, such as 80-95 wt % based on the total weight of the impact modified amorphous material.

The polymer in the impact modified amorphous material may be a bio-based polymer, a hybrid bio-based polymer or a petroleum-based polymer, or a mixture thereof. These terms are defined above and also include recycled polymers and recycled materials comprising bio-based polymers, a hybrid bio-based polymers or a petroleum-based polymers as disclosed above.

In a preferred embodiment, the polymer is selected from the group consisting of polyesters, polyacrylates and polystyrenes. These term are defined above. In a preferred embodiment, the polymer is selected from the group consisting of polyethylene terephthalate (PET), poly(ethylene glycol-co-2,2,4,4-tetramethyl-1,3-cyclobutanediol terephthalate) (PETT), poly(ethylene glycol-co-1,4-cyclohexanedimethanol terephthalate) (PETG) and poly(methyl methacrylate) (PMMA). In an even more preferred embodiment, the polymer is selected from the group consisting of polyethylene terephthalate (PET) polyester and poly(methyl methacrylate) (PMMA).

The toy building element made of an impact modified amorphous material also comprises an impact modifier as described above. The impact modifier may be a reactive impact modifier, a non-reactive impact modifier or a mixture thereof. In one embodiment, the amount of impact modifier in the impact modified amorphous material is in the range of 1-30 wt % based on the total weight of the impact modified amorphous material. In some embodiments, the amount of impact modifiers is in the range of 2-25 wt %, more preferred 3-20 wt % or 4-15 wt % or even more preferred 5-15 wt % based on the total weight of the impact modified amorphous material.

### EXAMPLES

In the examples below, it is described how samples are prepared, heat treated and evaluated by different tests. Three of the tests are the “Charpy v-notch test”, the “Shrinkage test” and the “Enthalpic relaxation test”.

Charpy v-Notch Test

Moulded plastic rods according to ISO 179-1:2010 with dimensions of 10.0×4.0×82.0 mm³, B×W×L, and in the relevant material to be tested were cut according to ISO 179-1-A with a notch cutter (ZNO, Zwick, Germany) with a notch tip diameter of 0.5 mm. The notched specimens were placed with v-notch opposite pendulum and tested in a pendulum impact machine (HOT, Zwick, Germany) according to the principles described in ISO 179-1:2010.

### Shrikage Test

Shrinkage is measured as the average of the length and width of an ISO 527-1 BA tensile element, measured by caliper, relative to the initial dimensions, according to the formula:

$$\% Shrinkage {( t = x )}_{avg} = ( 1 - \frac{( ( \frac{length ( t = x )}{length ( t = 0 )} ) + ( \frac{width ( t = x )}{width ( t = 0 )} ) )}{2} ) \cdot 100 \%$$

where t=x is the dimensions after some time of heat treatment and t=0 are the initial dimensions of the element.

### Enthalpic Relaxation Test (See Examples 7 and 9)

The value of enthalpic relaxation is measured during heating a 20 mg flat cut-out sample to 300° C. at the glass transition temperature (Tg), as described in ‘E. Andersen, R. Mikkelsen, S. Kristiansen, M. Hinge, Accelerated physical ageing of poly(1,4-cyclohexylenedimethylene-co-2,2,4,4-tetramethyl-1,3-cyclobutanediol terephthalate), RSC Adv., 2019, 9, 14209-14219’.

### Example 1. Preparation and Heat Treatment of Injection Moulded Samples

To evaluate the stress relaxation property of an injection moulded polymeric material with and without heat treatment according to the present disclosure, stress relaxation experiments were conducted. A stress relaxation experiment measures the stress applied by a specimen under constant strain.

The stress relaxation measurements were carried out in a uniaxial tension in a Zwick-Roell Kappa Multistation 5×10 kN on 1BA ISO 527-2:2012 injection moulded specimens.

The Charpy v-notch impact toughness measurements were carried out as described above. Injection moulded elements were inserted into a climate chamber (HPP260, Memmert, GER) controlled at a given temperature and 50% RH for a set time, taken out and left for at least 24 h before testing. The elements were then inserted into the tensile grips, and the device was left to control the temperature of the testing chamber. The elements were left in the tensile grips until the temperature was equilibrated. The materials investigated are listed in Table 1 below.

TABLE 1
Polymer and impact modifiers in the materials investigated

| | | Glass transition |
|---|---|---|
| Polymer | | temperature |
| (tradename (company)) | Impact modifier | (T_{g}) |
| PMMA (Optix ® CA-924 | Yes, MBS-type | 90° C. |
| (Plaskolite)) | | |
| PETT (GMX201 | No | 90° C. |
| (Eastman)) | | |
| PETG (SkyGreen KN100 | No | 80° C. |
| (SK Chemicals)) | | |
| rPET (rPET C101 | Yes, 10% Paraloid ™ EXL- | 80° C. |
| (PolyQuest)) | 3691J, 2.5% ELVALOY | |
| | PTW. | |
| rPET | Yes, 5% Paraloid ™ EXL- | 80° C. |
| | 3691J, 6% ELVALOY PTW. | |
| rPET | Yes, 5% Paraloid ™ EXL- | 80° C. |
| | 3691J, 0% ELVALOY PTW. | |
| rPET | Yes, 10% Paraloid ™ EXL- | 80° C. |
| | 3691J, 0% ELVALOY PTW. | |

### Example 2: Stress Relaxation Measurements of Injection Moulded Samples with and without Heat Treatment

After temperature equilibration, the specimens prepared in Example 1 were loaded to 1% strain at 1 mm/min and the specimen's stress was measured for 48 h to give a stress-strain curve of the stress relaxation experiment. Strain was determined by measuring displacement between two reference points using a video extensometer and stress was measured in the load cells of the equipment.

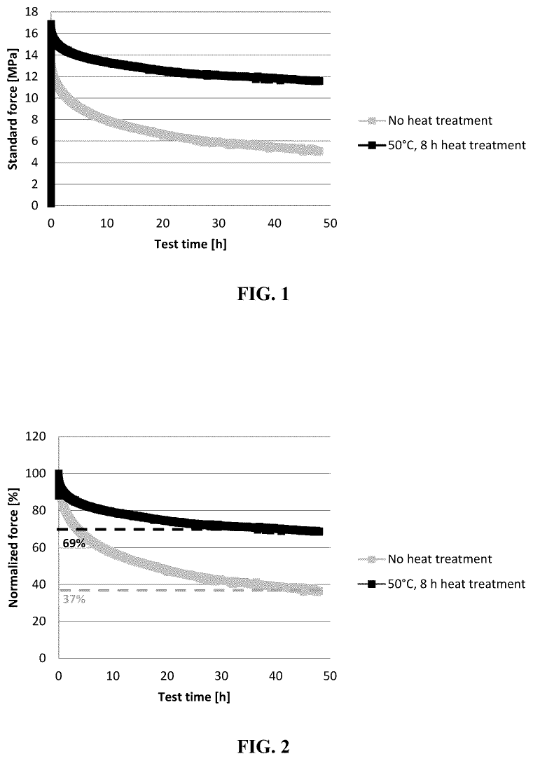

The stress-strain curve for rPET (10% PARALOID EXL, 2.5% ELVALOY) before and after heat treatment of 8 h at 50° C. are shown in FIG. 1. It is seen from this figure that the impact modified rPET exhibits clear stress relaxation behavior by decreasing stress when held at constant strain. This loss in stress over time decreases significantly with heat treatment.

Quantifying the stress relaxation of a material can be determined by evaluating the drop in stress during a specified testing period with constant strain. E.g. the difference between stress measured at t=0 hours and t=48 hours at 1% strain. Calculating the relative decrease in stress during such an experiment can be helpful to compare materials. This is done by normalizing the stress measured during the experiment by the stress when the strain was initially achieved, which is equal to the maximum stress during the experiment. This can be done following the formula:

$${Normalized}_{stress} = \frac{Stress ( t )}{Stress ( max )}$$

FIG. 2 shows the plot, which was generated by using the normalized stress data.

From FIG. 2 the normalized stress of the experiment at 48 h shows how well the stress is retained, and will be called the relative stress retention, which for this example is 69% and 37% for the heat treated (8 h, 50° C.) and untreated specimen, respectively. The higher relative stress retention, the better stress relaxation and hence functional durability. The results clearly show that heat treatment of 8 h improves the relative stress retention significantly, which improves functional durability.

### Example 3: Stress Relaxation Measurements of Injection Moulded Samples Subjected to Different Heat Treatment Periods

It was also investigated how the heat treatment period affects the stress retention. More precisely, heat treatment periods of 0, 8, 24 and 168 hours were applied to the injection moulded sample made of rPET (10% PARALOID EXL, 2.5% ELVALOY) and investigated.

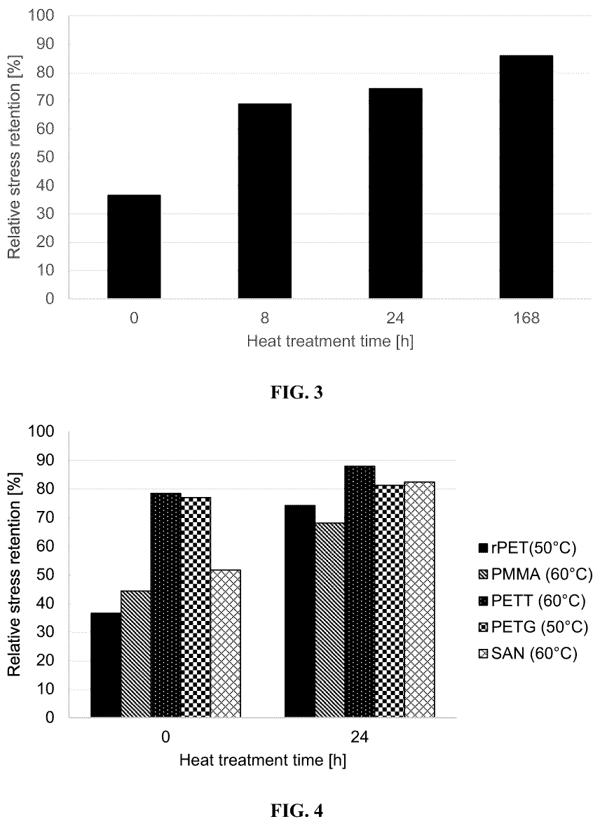

The results are shown in FIG. 3. It is clearly seen that by increasing the heat treatment period at a constant temperature, the relative stress retention is increased. This means that by increasing the heat treatment period, the functional durability of a material is improved.

### Example 4: Stress Relaxation Measurements of Injection Moulded Samples Made of Different Polymers

Stress retention for different samples made of different polymers were also investigated. Both unmodified and impact modified samples were tested. The sample comprising rPET and 10% impact modifier was heat treated at 50 degrees C. for 24 hours, i.e. 30 degrees C. below its glass transition temperature. The sample comprising PMMA and impact modifier was heat treated at 60 degrees C. for 24 hours, i.e. 30 degrees C. below its glass transition temperature. The sample comprising PETT and no modifier was heat treated at 60 degrees C. for 24 hours, i.e. at 30 degrees C. below its glass transition temperature. The sample comprising PETG and no modifier was heat treated at 50 degrees C. for 24 hours, i.e. at 30 degrees C. below its glass transition temperature.

The results are shown in FIG. 4. It is seen that heat treatment improves the relative stress retention of impact modified rPET and PMMA as well as unmodified PETG and PETT (change from 4% to 38% in stress retention).

### Example 5: Stress Relaxation Measurements of Injection Moulded Samples Containing Different Amounts of Impact Modifier

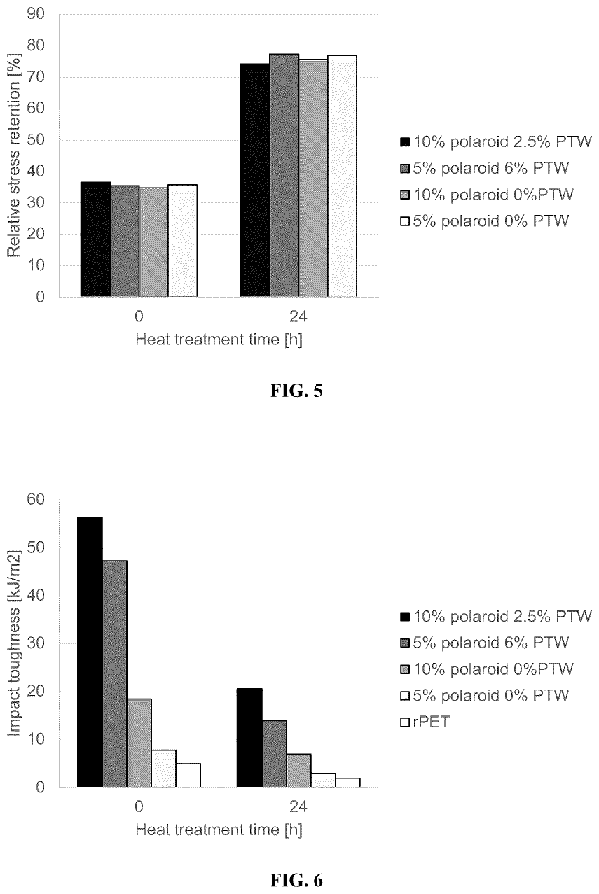

Stress retention of rPET samples comprising various concentrations of impact modifier was also investigated. The results are shown in FIG. 5. It is seen that heat treatment improves the stress retention of rPET at various impact modification levels.

### Example 6: Charpy v-Notch Impact Toughness Measurements of Injection Moulded Samples Containing Different Amounts of Impact Modifier

Charpy v-notch impact toughness of rPET samples comprising various concentrations of impact modifier was investigated. The results are shown in FIG. 6. It is seen that increased concentration of impact modifier increases the impact toughness of rPET. Increasing the impact toughness of rPET is required for durable applications.

### Example 7: Impact Toughness and Enthalpic Relaxation Measurements of Injection Moulded Samples

It was also investigated how the heat treatment period affects the impact toughness and the enthalpic relaxation. More precisely, heat treatment periods of 0, 15 minutes, 30 minutes, 8 hours and 24 hours were applied to the injection moulded samples made of rPET (10% PARALOID EXL, 2.5% ELVALOY) and investigated. The heat treatment temperature was 60 degrees C. corresponding to 20 degrees below rPET's glass transition temperature.

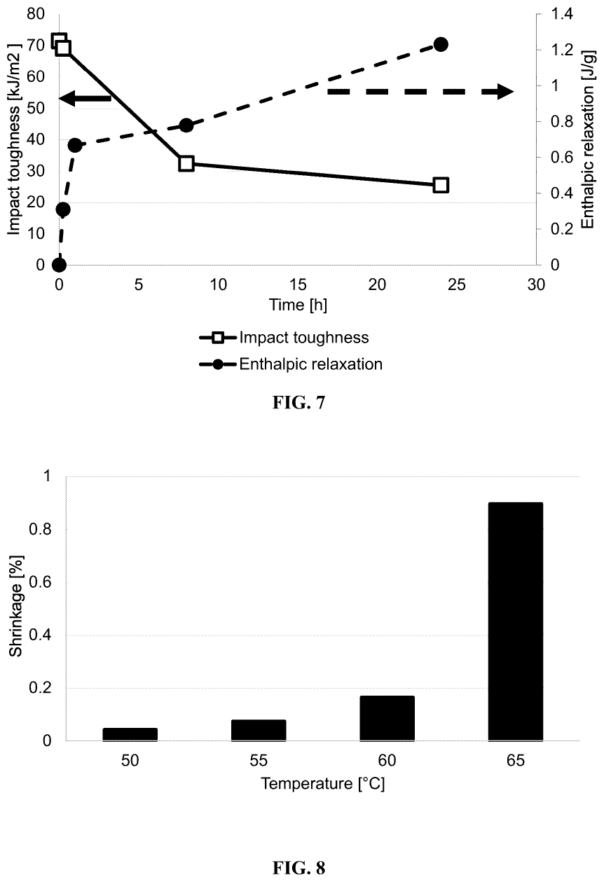

The results are shown in FIG. 7. It is seen that the enthalpic relaxation increases strongly during the first 30 minutes of the heat treatment. After that, the enthalpic relaxation is still increasing, but not as strongly. The enthalpic relaxation has increased to more than 0.3 J/g already after 15 minutes of heat treatment.

The results presented in FIG. 7 also show that the impact toughness decreases as the enthalpic relaxation increases. This result is expected because heat treatment under the glass transition temperature causes embrittlement of plastic parts prone to physical ageing, such as PET, PMMA and SAN (explained for example in RSC. Advances, 2019, 9, 14209-14219).

### Example 8: Shrinkage Measurements of Injection Moulded Samples

Shrinkage of heat treated injection moulded samples made of rPET (10% PARALOID EXL, 2.5% ELVALOY) were investigated after subjecting the injection moulded samples to heat treatment for 24 hours at various temperatures: 50 degrees C. (corresponding to 30 degrees below rPET's glass transition temperature), 55 degrees C. (corresponding to 25 degrees below rPET's glass transition temperature), 60 degrees C. (corresponding to 20 degrees below rPET's glass transition temperature) and 65 degrees C. (corresponding to 15 degrees below rPET's glass transition temperature).

The results are shown in FIG. 8. The results clearly show that the shrinkage increases when increasing the heat treatment temperature. Shrinkages below 0.2% are seen for heat treatment temperatures of 60 degrees C. or below, which corresponds to temperatures below 20 degrees C. below glass transition temperature. At a heat treatment temperature of 65 degrees C. corresponding to 15 degrees C. below the glass transition temperature the shrinkage is more than 0.9%, which is not acceptable according to the present disclosure, which is focused on manufacturing toy building elements with improved functional durability.

### Example 9: Charpy v-Notch Impact Toughness and Relative Stress Retention Measurements of Injection Moulded Samples

Charpy v-notch impact toughness and relative stress retention were also investigated for injection moulded samples made of rPET (10% PARALOID EXL, 2.5% ELVALOY). The measurement were performed after heat treatment of injection moulded samples for 24 hours at different temperatures: 23 degrees C., 50 degrees C. (corresponding to 30 degrees below rPET's glass transition temperature), 55 degrees C. (corresponding to 25 degrees below rPET's glass transition temperature), 60 degrees C. (corresponding to 20 degrees below rPET's glass transition temperature) and 70 degrees C. (corresponding to 10 degrees below rPET's glass transition temperature).

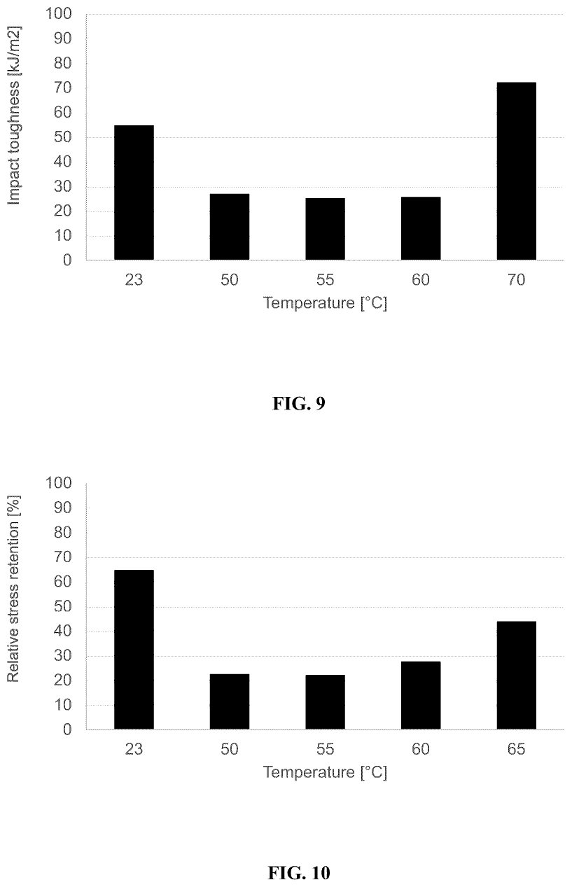

The results are shown in FIGS. 9 and 10. FIG. 9 shows the results of the Charpy v-notch impact toughness test. The results presented in FIG. 9 show that the impact toughness decreases with increasing heat treatment temperature until 60 degrees C. (corresponding to 20 degrees below rPET's glass transition temperature). After that, the impact toughness increases when approaching the glass transition temperature. This loss in impact toughness caused by subjecting the injection moulded samples to the heat treatment according to the present disclosure is of minor importance as long as the addition of impact modifier to the virgin polymer material has increased the impact toughness to such a level that the decrease caused by the heat treatment will still render the impact toughness of the heat treated element at an acceptable level. It is important to note that the present disclosure is focused on increasing the stress relaxation property, and that a decrease in impact toughness cannot be avoided; but the loss can be made negligible by ensuring that the starting level is sufficiently high.

In FIG. 10, the results of the stress relaxation test are presented. These results clearly show that heat treating the injection moulded samples at temperatures of 50 degrees C. and 55 degrees C., corresponding to 25 and 30 degrees below rPET's glass transition temperature, respectively, provides the best stress relaxation and that heat treatment at 65 degrees C. (corresponding to 15 degrees C. below rPET's glass transition temperature) provides poor stress relaxation. These results support the findings that an upper limit of the heat treatment temperature at 20 degrees below the glass transition temperature will provide injection moulded toy building elements with acceptable functional durability.

1. A method for the manufacture of a toy building element with improved functional durability made of an impact modified amorphous material having an enthalpic relaxation of at least 0.3 J/g, such as in the range of 0.3 to 4 J/g and a shrinkage of maximum 0.2%, said method comprising the steps of:
a) providing a resin comprising a polymer and an impact modifier,
b) processing the resin to produce the amorphous toy building element,
c) heat treating the amorphous toy building element at a heat treatment temperature of at least 40 degrees C. for a period of at least 15 minutes, and
d) cooling the heat treated toy building element to ambient temperature,
wherein the upper limit of the heat treatment temperature in step c is 20 degrees C. below the onset of glass transition temperature (Tg) of the impact modified amorphous material.

2. The method according to claim 1, wherein the amount of polymer in the resin is at least 50 wt % based on total weight of the resin.

3. The method according to claim 1, wherein the polymer is selected from the group consisting of polyesters, polyacrylates and polystyrenes.

4. The method according to claim 1, wherein the polymer is selected from the group consisting of polyethylene terephthalate (PET) and poly(methyl methacrylate) (PMMA).

5. The method according to claim 1, wherein the amount of impact modifier in the resin is in the range of 1-30 wt % based on total weight of the resin.

6. The method according to claim 1, wherein the impact modifier is a reactive impact modifier, a non-reactive impact modifier or a mixture thereof.

7. The method according to claim 1, wherein the amorphous toy building element is heat treated in step c at a heat treatment temperature in the range of 20-45 degrees C. below the onset of glass transition temperature of the impact modified amorphous material, provided that the lower limit of the heat treatment temperature is 40 degrees C. or above.

8. The method according to claim 1, wherein the amorphous toy building element is heat treated in step c for a period of 15 minutes to 4 weeks.

9. The method according to claim 1, wherein the amorphous toy building element is manufactured by injection moulding the resin in step b.

10. A toy building element with improved functional durability made of an impact modified amorphous material comprising a polymer and an impact modifier and having an enthalpic relaxation of at least 0.3 J/g, such as in the range of 0.3 to 4 J/g and a shrinkage of maximum 0.2%.

11. The toy building element according to claim 10, wherein the amount of polymer in the impact modified amorphous material is at least 50 wt % based on total weight of the impact modified amorphous material.

12. The toy building element according to claim 10, wherein the polymer is selected from the group consisting of polyesters, polyacrylates and polystyrenes.

13. The toy building element according to claim 10, wherein the polymer is selected from the group consisting of polyethylene terephthalate (PET) polyester and poly(methyl methacrylate) (PMMA).

14. The toy building element according to claim 10, wherein the amount of impact modifier in the impact modified amorphous material is in the range of 1-30 wt % based on total weight of the impact modified amorphous material.

15. The toy building element according to claim 10, wherein the impact modifier is a reactive impact modifier, a non-reactive impact modifier or a mixture thereof.

16. A method for the manufacture of a toy building element, comprising the steps of:
a) providing a resin comprising a polymer and an impact modifier, the amount of polymer in the resin is at least about 50 wt % and the amount of impact modifier in the resin is in the range of about 1-30 wt % each based on the total weight of the resin;
b) processing the resin to produce the amorphous toy building element;
c) heat treating the amorphous toy building element at a heat treatment temperature of at least about 40 degrees C. for a period of at least about 15 minutes, but below the heat treatment temperature of the onset of glass transition temperature (Tg) of the impact modified amorphous material; and
d) cooling the heat treated toy building element to ambient temperature.
